(19) United States
(12) Patent Application Publication
(10) Pub. No.: US 2026/0128858 A1
(43) Pub. Date: May 7, 2026

(54) ENCRYPTOR AND MEMORY CONTROLLER INCLUDING THE SAME

(71) Applicant: SAMSUNG ELECTRONICS CO., LTD., Suwon-si (KR)

(72) Inventors: Wijik LEE, Suwon-si (KR); Jiyoup KIM, Suwon-si (KR); Dongmin SHIN, Suwon-si (KR)

(73) Assignee: SAMSUNG ELECTRONICS CO., LTD., Suwon-si (KR)

(21) Appl. No.: 19/226,895

(22) Filed: Jun. 3, 2025

(30) Foreign Application Priority Data
Nov. 5, 2024 (KR) 10-2024-0155052

(51) Int. Cl. H04L 9/06

(52) U.S. Cl. CPC H04L 9/0631

(57) ABSTRACT

An encryptor includes a first calculator, a second calculator, a third calculator and a fourth calculator. The first calculator receives plaintext data, performs an XOR operation based on one of a plurality of round key data during each round, and outputs ciphertext data. The second calculator performs a substitution operation on an output of the first calculator using an SBOX during each round. The SBOX is implemented based on a first corrected lookup table that is converted from a first standard lookup table. The third calculator performs a row transformation operation on an output of the second calculator during each round. The fourth calculator performs a column transformation operation on an output of the third calculator using the SBOX and at least one TBOX during each round. The at least one TBOX is implemented based on at least one second corrected lookup table that is converted from at least one second standard lookup table.

### CROSS-REFERENCE TO RELATED APPLICATION

This application claims priority under 35 USC § 119 to Korean Patent Application No. 10-2024-0155052 filed on Nov. 5, 2024 in the Korean Intellectual Property Office (KIPO), the contents of which are herein incorporated by reference in their entirety.

### BACKGROUND

### 1. Field

Example embodiments relate generally to semiconductor integrated circuits, and more particularly to encryptors and memory controllers including the encryptors.

### 2. Description of the Related Art

An encryption technique is commonly used to ensure the security of data transmission. In the encryption technique, a plaintext may be encrypted at a transmission side, while ciphertext may be decrypted at a reception side. The process of encrypting plaintext and decrypting ciphertext may be collectively referred to as the encryption technique.

Since encryption operations are usually slow, an encryptor may be implemented as hardware to be applied to a device, such as smart cards. For example, various encryption algorithms, such as a data encryption standard (DES), an advanced encryption standard (AES), an ARIA standard, may be used.

### SUMMARY

At least one example embodiment of the present disclosure provides an encryptor capable of having low latency and high throughput characteristics and performing high-speed operations.

At least one example embodiment of the present disclosure provides a memory controller including the encryptor.

According to an aspect of the disclosure, a processor may perform an XOR operation on plaintext data based on one of a plurality of round key data to obtain a first calculation output; perform a substitution operation on the first calculation output using a substitution box (SBOX) that is implemented based on a first corrected lookup table converted from a first standard lookup table, to obtain a second calculation output; perform a row transformation operation on the second calculation output to obtain a third calculation output; perform a column transformation operation on the third calculation output using the SBOX and a transformation box (TBOX) that is implemented based on a second corrected lookup table converted from a second standard lookup table, to obtain a fourth calculation output; and obtain ciphertext data based on the third calculation output and the fourth calculation output.

According to another aspect of the disclosure, a memory controller may include: a processor; and a buffer memory configured to temporarily store data that is processed by the processor; wherein the processor is configured to perform an encryption operation to: perform an XOR operation on first data based on one of a plurality of round key data to obtain a first calculation output; perform a substitution operation on the first calculation output using a substitution box (SBOX) that is implemented based on a first corrected lookup table converted from a first standard lookup table, to obtain a second calculation output; perform a row transformation operation on the second calculator output to obtain a third calculation output; perform a column transformation operation on the third calculation output using the SBOX and transformation box (TBOX) that is implemented based on second corrected lookup table converted from second standard lookup table, to obtain a fourth calculation output; and obtain ciphertext data based on the third calculation output and the fourth calculation output.

According to an aspect of the disclosure, an encryption method performed by at least one processor, may include: performing an XOR operation on plaintext data based on one of a plurality of round key data to obtain a first calculation output; performing a substitution operation on the first calculation output using a substitution box (SBOX) that is implemented based on a first corrected lookup table converted from a first standard lookup table, to obtain a second calculation output; performing a row transformation operation on the second calculation output to obtain a third calculation output; performing a column transformation operation on the third calculation output using the SBOX and a transformation box (TBOX) that is implemented based on a second corrected lookup table converted from a second standard lookup table, to obtain a fourth calculation output; and obtaining ciphertext data based on the third calculation output and the fourth calculation output.

According to example embodiments, an encryptor generates ciphertext data by performing a plurality of rounds based on plaintext data, and includes a first calculator, a second calculator, a third calculator and a fourth calculator. The first calculator receives the plaintext data, performs an XOR operation based on one of a plurality of round key data during each round, and outputs the ciphertext data. The second calculator performs a substitution operation on an output of the first calculator using a substitution box (SBOX) during each round. The SBOX is implemented based on a first corrected lookup table that is converted from a first standard lookup table. The third calculator performs a row transformation operation on an output of the second calculator during each round. The fourth calculator performs a column transformation operation on an output of the third calculator using the SBOX and at least one transformation box (TBOX) during each round. The at least one TBOX is implemented based on at least one second corrected lookup table that is converted from at least one second standard lookup table.

According to example embodiments, a memory controller includes a processor, a buffer memory and an encryptor. The buffer memory temporarily stores data that is processed by the processor. The encryptor performs an encryption operation on first data that is received from the buffer memory, and generates ciphertext data by performing a plurality of rounds based on the first data that is plaintext data. The encryptor includes a first calculator, a second calculator, a third calculator and a fourth calculator. The first calculator receives the first data, performs an XOR operation based on one of a plurality of round key data during each round, and outputs the ciphertext data. The second calculator performs a substitution operation on an output of the first calculator using a substitution box (SBOX) during each round. The SBOX is implemented based on a first corrected lookup table that is converted from a first standard lookup table. The third calculator performs a row transformation operation on an output of the second calculator during each round. The fourth calculator performs a column transformation operation on an output of the third calculator using the SBOX and at least one transformation box (TBOX) during each round. The at least one TBOX is implemented based on at least one second corrected lookup table that is converted from at least one second standard lookup table.

According to example embodiments, an encryptor generates ciphertext data by performing an initial round and first to Nth rounds based on plaintext data, where N is a positive integer greater than or equal to two, and includes a first calculator, a second calculator, a third calculator and a fourth calculator. The first calculator performs an XOR operation based on initial round key data and first to Nth round key data. The second calculator performs a substitution operation using a substitution box (SBOX). The SBOX is implemented based on a first corrected lookup table that is converted from a first standard lookup table. The third calculator performs a row transformation operation. The fourth calculator performs a column transformation operation using the SBOX, a first transformation box (TBOX) and a second TBOX. The first and second TBOXs are implemented based on second and third corrected lookup tables that are converted from second and third standard lookup tables, respectively. During the initial round, the first calculator performs the XOR operation on the plaintext data and the initial round key data. During an Mth round among the first to Nth rounds, where M is a positive integer greater than or equal to one and smaller than or equal to (N−1), the second calculator performs the substitution operation on an output of the first calculator using the SBOX, the third calculator performs the row transformation operation on an output of the second calculator, the fourth calculator performs the column transformation operation on an output of the third calculator using the SBOX and the first and second TBOXs, and the first calculator performs the XOR operation on an output of the fourth calculator and Mth round key data. During the Nth round, the second calculator performs the substitution operation on the output of the first calculator using the SBOX, the third calculator performs the row transformation operation on the output of the second calculator, and the first calculator generates the ciphertext data by performing the XOR operation on the output of the third calculator and the Nth round key data. The first, second and third standard lookup tables are implemented based on advanced encryption standard (AES) standard. The first corrected lookup table is obtained by XOR-shifting the first standard lookup table based on a first value. The second and third corrected lookup tables are obtained by XOR-shifting the second and third standard lookup tables, respectively, based on a second value different from the first value. The first value and the second value are determined such that a logic depth of each of the SBOX and the first and second TBOXs is minimized.

In the encryptor and the memory controller according to example embodiments, the SBOX may be implemented based on the first corrected lookup table that is converted from the first standard lookup table, and the at least one TBOX may be implemented based on the at least one second corrected lookup table that is converted from the at least one second standard lookup table. For example, the first corrected lookup table may be obtained by XOR-shifting the first standard lookup table based on the first value, the at least one second corrected lookup table may be obtained by XOR-shifting the at least one second standard lookup table based on the second value different from the first value, and the first value and the second value may be determined such that the logic depth of each of the SBOX and the TBOX is minimized. Such XOR-shifted lookup tables may be used rather than conventional lookup tables, and hardware including logic gates with the reduced critical path may be implemented based on the XOR-shifted lookup tables. Accordingly, the low latency and high throughput characteristics may be achieved, and the high-speed operations may be performed.

### BRIEF DESCRIPTION OF DRAWINGS

The above and/or other aspects will be more apparent by describing certain example embodiments, with reference to the accompanying drawings, in which:

FIG. 1 is a block diagram illustrating an encryptor according to example embodiments;

FIG. 2 is a flowchart illustrating a method of operating an encryptor according to example embodiments;

FIGS. 3A, 3B, 3C, 3D and 3E are diagrams for describing operations in FIG. 2;

FIGS. 4A, 4B, 4C, 4D, 4E, 4F, 4G and 4H are diagrams for describing operations in FIGS. 1, 2, 3A, 3B, 3C, 3D and 3E;

FIG. 5 is a block diagram illustrating an example of a fourth calculator included in an encryptor according to example embodiments;

FIG. 6 is a diagram for describing a logic depth of an SBOX and a TBOX included in a fourth calculator of FIG. 5;

FIGS. 7A, 7B and 7C are diagrams for describing an SBOX, a first TBOX and a second TBOX included in a fourth calculator of FIG. 5;

FIG. 8 is a block diagram illustrating an example of a fourth calculator included in an encryptor according to example embodiments;

FIG. 9 is a flowchart illustrating a method of designing an encryptor according to example embodiments;

FIG. 10 is a block diagram illustrating a memory controller and a memory system including the memory controller according to example embodiments;

FIG. 11 is a block diagram illustrating a memory controller according to example embodiments;

FIGS. 12A and 12B are block diagrams illustrating examples of a memory device that is controlled by a memory controller according to example embodiments; and

FIG. 13 is a block diagram illustrating an electronic system including an encryptor according to example embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

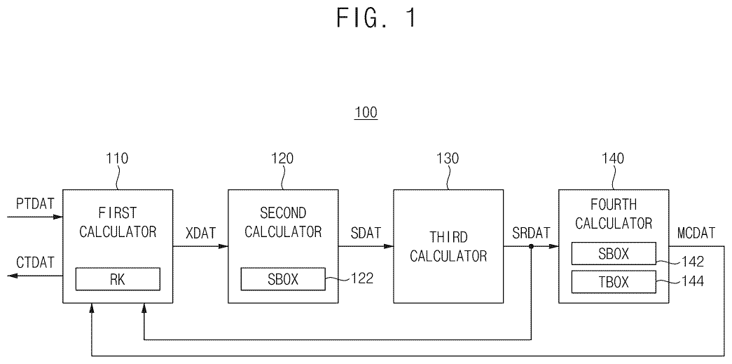

FIG. 1 is a block diagram illustrating an encryptor according to example embodiments.

Referring to FIG. 1, an encryptor 100 includes a first calculator 110, a second calculator 120, a third calculator 130 and a fourth calculator 140.

The encryptor 100 generates ciphertext data CTDAT by performing a plurality of rounds based on plaintext data PTDAT. For example, the plurality of rounds may include an initial round and first to Nth rounds, where N is a positive integer greater than or equal to two. The plurality of rounds may refer to a series of operations or transformation steps (e.g., substitution, permutation, key mixing, and/or XOR) that are applied to the plaintext data PTDAT.

In some example embodiments, the encryptor 100 may be implemented based on the advanced encryption standard (AES) standard or algorithm, or a processor (e.g., an encryption processor, an encryption accelerator, a dedicated cryptographic processor, and/or a hardware security module (HSM)) configured to execute the advanced encryption standard (AES) standard or algorithm. The processor may include logic gates configured to perform AES operations, or may interact with the logic gates provided outside the processor. In other words, the encryptor 100 may be an AES encryptor or encryption device. However, example embodiments are not limited thereto, and the encryptor 100 may be implemented based on at least one of various other algorithms.

The first calculator 110 may receive the plaintext data PTDAT, perform an XOR operation based on one of a plurality of round key data RK to generate one of a plurality of first calculation data XDAT during each round, and output the ciphertext data CTDAT. For example, the plurality of round key data RK may include initial round key data corresponding to the initial round, and first to Nth round key data corresponding to the first to Nth rounds, respectively. For example, one input data may be received in each round, the XOR operation may be performed on the one input data and one round key data in each round, and one first calculation data may be generated in each round. For example, the one input data may be the plaintext data PTDAT, an output of the fourth calculator 140, or an output of the third calculator 130. The first calculator 110 may be referred to as an XOR calculator.

The second calculator 120 performs a substitution operation on one of the plurality of first calculation data XDAT, which is an output of the first calculator 110, using a substitution box (SBOX) 122 during each round to generate one of a plurality of second calculation data SDAT during each round. For example, the one first calculation data may be received in each round, the substitution operation may be performed on the one first calculation data in each round, and one second calculation data may be generated in each round. The second calculator 120 may be referred to as a substitution calculator.

The SBOX 122 is implemented based on a first corrected lookup table that is converted from a first standard lookup table. For example, the first standard lookup table may be implemented based on the AES standard, and may be defined in the AES standard. For example, the first corrected lookup table may be obtained by performing an XOR-shifting operation on the first standard lookup table. The first standard lookup table may be a pre-stored lookup table (e.g., a substitution box that provides a substitution for each byte of the state, so that each byte of the state is substituted with a value from the S-Box based on an input value), and the first corrected lookup table may be obtained by performing the XOR-shifting operation on the pre-stored lookup table. Hereinafter, an SBOX that is implemented based on the first standard lookup table may be referred to as a standard SBOX (SSBOX), and an SBOX that is implemented based on the first corrected lookup table according to example embodiments may be referred to as a corrected SBOX (CSBOX) to distinguish from the standard SBOX. In embodiments of the disclosure, the SBOX 122 included in the second calculator 120 may be the CSBOX.

The third calculator 130 performs a row transformation operation on one of the plurality of second calculation data SDAT, which is an output of the second calculator 120, during each round to generate one of a plurality of third calculation data SRDAT during each round. For example, the one second calculation data may be received in each round, the row transformation operation may be performed on the one second calculation data in each round, and one third calculation data may be generated in each round. The third calculator 130 may be referred to as a row transformation calculator.

The fourth calculator 140 performs a column transformation operation on one of the plurality of third calculation data SRDAT, which is the output of the third calculator 130, using an SBOX 142 and at least one transformation box (TBOX) 144 during each round to generate one of a plurality of fourth calculation data MCDAT during each round. For example, the one third calculation data may be received in each round, the column transformation operation may be performed on the one third calculation data in each round, and one fourth calculation data may be generated in each round. The fourth calculator 140 may be referred to as a column transformation calculator.

The SBOX 142 may be obtained by converting the first standard lookup table into the first corrected lookup table. The SBOX 122 may be substantially the same as the SBOX 142. In some example embodiments, the second calculator 120 and the fourth calculator 140 may share the same SBOX that is implemented based on the first corrected lookup table.

The at least one TBOX 144 may be obtained by converting at least one second standard lookup table into at least one second corrected lookup table. For example, the at least one second standard lookup table may be implemented based on the AES standard, and may be defined to perform operations and/or calculations defined in the AES standard. For example, the at least one second corrected lookup table may be obtained by performing the XOR-shifting operation on the at least one second standard lookup table. The second standard lookup table may be a pre-stored lookup table (e.g., a transformation box that contains precomputed values of the state, which are obtained by applying SubBytes and ShiftRows transformations to an input value), and the second corrected lookup table may be obtained by performing the XOR-shifting operation on the pre-stored lookup table. Hereinafter, a TBOX that is implemented based on the at least one second standard lookup table may be referred to as a standard TBOX (STBOX), and a TBOX that is implemented based on the at least one second corrected lookup table according to example embodiments may be referred to as a corrected TBOX (CTBOX) to distinguish from the standard TBOX. In embodiments of the disclosure, the TBOX 144 included in the fourth calculator 140 may be the CTBOX.

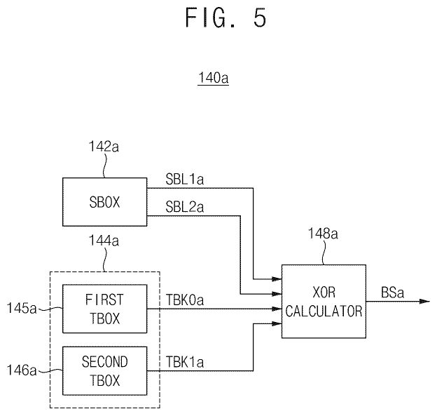

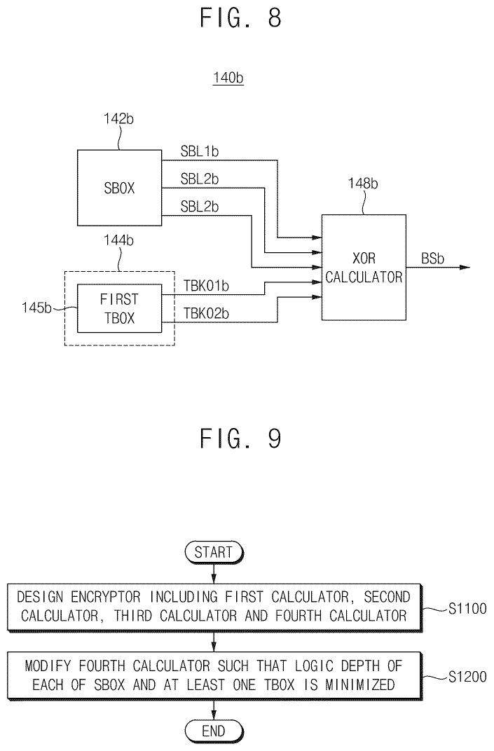

In some example embodiments, as will be described with reference to FIG. 5, the at least one TBOX 144 may include a first TBOX and a second TBOX. In other example embodiments, as will be described with reference to FIG. 8, the at least one TBOX 144 may include only one TBOX.

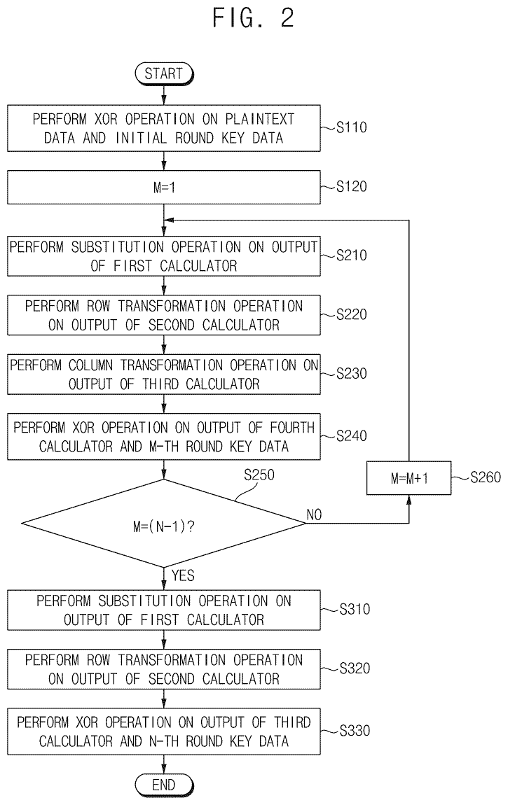

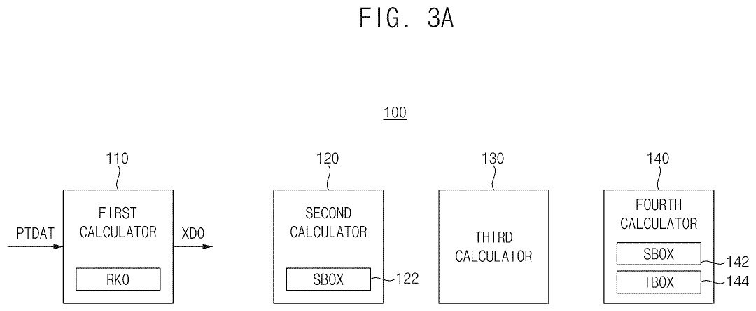

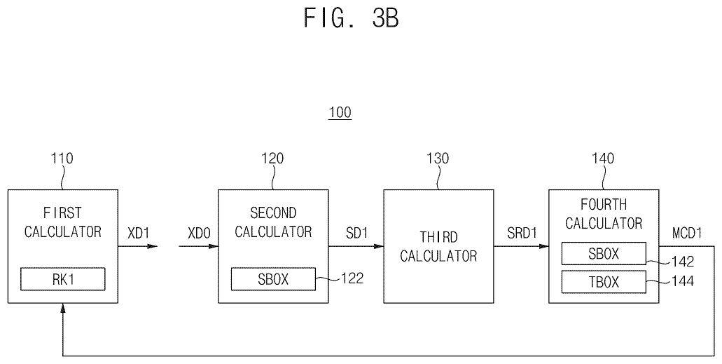

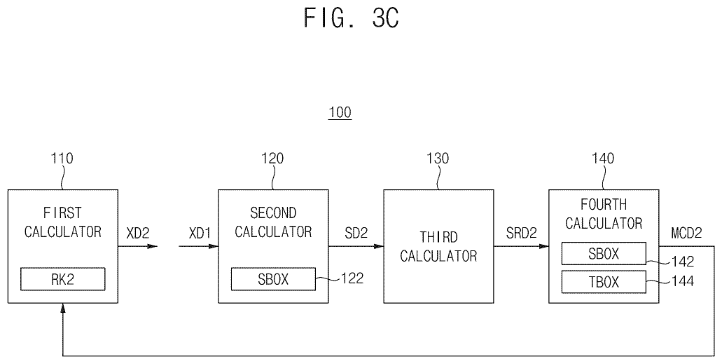

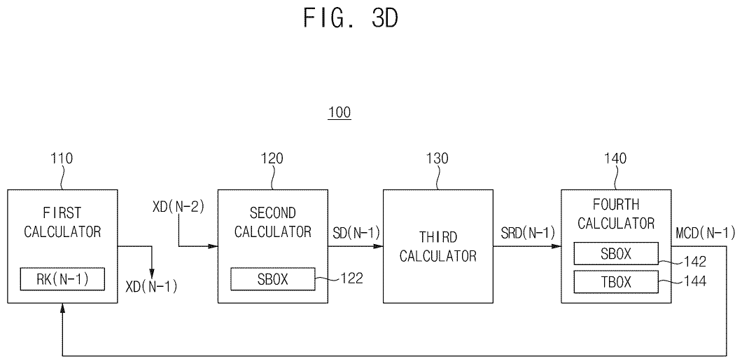

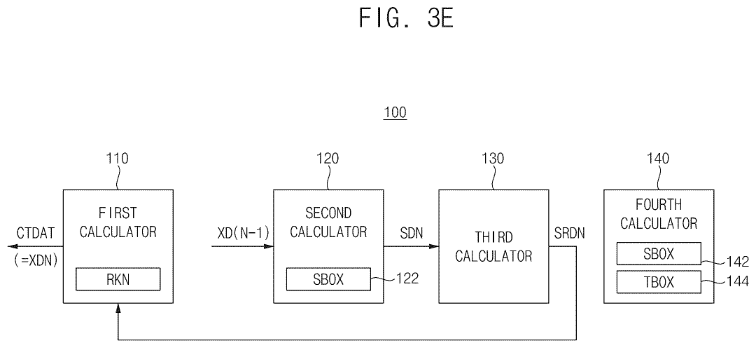

FIG. 2 is a flowchart illustrating a method of operating an encryptor according to example embodiments. FIGS. 3A, 3B, 3C, 3D and 3E are diagrams for describing operations in FIG. 2.

Referring to FIGS. 2, 3A, 3B, 3C, 3D and 3E, the encryptor 100 encrypts the plaintext data PTDAT to generate the ciphertext data CTDAT.

An encryption process by the encryptor 100 may include an initial round, intermediate rounds and a final round. For example, as described with reference to FIG. 1, when the plurality of rounds performed by the encryptor 100 include the initial round and the first to Nth rounds, the first to (N−1)th rounds among the first to Nth rounds may correspond to the intermediate rounds, and the Nth round may correspond to the final round.

In some example embodiments, when the encryptor 100 is implemented based on the AES standard, the plaintext data PTDAT may be data of 128 bits, and each round key data may be one of data of 128 bits, data of 192 bits and data of 256 bits. For example, if each round key data is data of 128 bits, the remaining rounds other than the initial round may be ten rounds (e.g., N=10). For example, if each round key data is data of 192 bits, the remaining rounds other than the initial round may be twelve rounds (e.g., N=12). For example, if each round key data is data of 256 bits, the remaining rounds other than the initial round may be fourteen rounds (e.g., N=14).

In a method of operating the encryptor 100 according to example embodiments, operation S110 may correspond to the initial round, operations S210, S220, S230, S240, S250 and S260 may correspond to the intermediate rounds, and operations S310, S320 and S330 may correspond to the final round.

In the initial round, as illustrated in FIG. 3A, the first calculator 110 may perform the XOR operation on the plaintext data PTDAT and an initial round key data RK0 to generate initial first calculation data XD0 (operation S110). The initial round may be executed once.

Thereafter, a round count value M may be reset or initialized (operation S120). For example, the encryptor 100 may set the round count value M to one.

Thereafter, in the intermediate rounds, the second calculator 120 may perform the substitution operation on the output of the first calculator 110 using the SBOX 122 (operation S210). The third calculator 130 may perform the row transformation operation on the output of the second calculator 120 (operation S220). The fourth calculator 140 may perform the column transformation operation on the output of the third calculator 130 using the SBOX 142 and the at least one TBOX 144 (operation S230). The first calculator 110 may perform the XOR operation on the output of the fourth calculator 140 and Mth round key data (operation S240).

The intermediate rounds may be executed (N−1) times. For example, when the round count value M is less than (N−1) (operation S250: NO), the round count value M may be increased by one (operation S260), and operations S210, S220, S230 and S240 may be repeatedly performed. When the round count value Mis equal to (N−1) (operation S250: YES), the final round may be executed.

For example, in the first round (e.g., a first intermediate round), as illustrated in FIG. 3B, the second calculator 120 may perform the substitution operation on the initial first calculation data XD0, which is the output of the first calculator 110, to generate second-first calculation data SD1. The third calculator 130 may perform the row transformation operation on the second-first calculation data SD1, which is the output of the second calculator 120, to generate third-first calculation data SRD1. The fourth calculator 140 may perform the column transformation operation on the third-first calculation data SRD1, which is the output of the third calculator 130, to generate fourth-first calculation data MCD1. The first calculator 110 may perform the XOR operation on the fourth-first calculation data MCD1, which is the output of the fourth calculator 140, and first round key data RK1 to generate first-first calculation data XD1.

In a second round (e.g., a second intermediate round) subsequent to the first round, as illustrated in FIG. 3C, the second calculator 120 may perform the substitution operation on the first-first calculation data XD1 to generate second-second calculation data SD2. The third calculator 130 may perform the row transformation operation on the second-second calculation data SD2 to generate third-second calculation data SRD2. The fourth calculator 140 may perform the column transformation operation on the third-second calculation data SRD2 to generate fourth-second calculation data MCD2. The first calculator 110 may perform the XOR operation on the fourth-second calculation data MCD2 and second round key data RK2 to generate first-second calculation data XD2.

Thereafter, in an (N−1)th round, as illustrated in FIG. 3D, the second calculator 120 may perform the substitution operation on first-(N−2)th calculation data XD(N−2) to generate second-(N−1)th calculation data SD(N−1). The third calculator 130 may perform the row transformation operation on the second-(N−1)th calculation data SD(N−1) to generate third-(N−1)th calculation data SRD(N−1). The fourth calculator 140 may perform the column transformation operation on the third-(N−1)th calculation data SRD(N−1) to generate fourth-(N−1)th calculation data MCD(N−1). The first calculator 110 may perform the XOR operation on the fourth-(N−1)th calculation data MCD(N−1) and (N−1)th round key data RK(N−1) to generate first-(N−1)th calculation data XD(N−1).

Thereafter, in the final round, as illustrated in FIG. 3E, the second calculator 120 may perform the substitution operation on the first-(N−1)th calculation data XD(N−1), which is the output of the first calculator 110, using the SBOX 122 to generate the second-Nth calculation data SDN (operation S310). The third calculator 130 may perform the row transformation operation on the second-Nth calculation data SDN, which is the output of the second calculator 120, to generate third-Nth calculation data SRDN (operation S320). The first calculator 110 may perform the XOR operation on the third-Nth calculation data SRDN, which is the output of the third calculator 130, and Nth round key data RKN to generate first-Nth calculation data XDN (operation S330). The first-Nth calculation data XDN may be output as the ciphertext data CTDAT. The final round may be executed once. In the final round, the column transformation operation by the fourth calculator 140 may not be performed.

The initial round key data RK0, the first round key data RK1, the second round key data RK2, the (N−1)th round key data RK(N−1) and the Nth round key data RKN may be included in the plurality of round key data RK of FIG. 1. The initial first calculation data XD0, the first-first calculation data XD1, the first-second calculation data XD2, the first-(N−2)th calculation data XD(N−2), the first-(N−1)th calculation data XD(N−1) and the first-Nth calculation data XDN may be included in the plurality of first calculation data XDAT of FIG. 1. The second-first calculation data SD1, the second-second calculation data SD2, the second-(N−1)th calculation data SD(N−1) and the second-Nth calculation data SDN may be included in the plurality of second calculation data SDAT of FIG. 1. The third-first calculation data SRD1, the third-second calculation data SRD2, the third-(N−1)th calculation data SRD(N−1) and the third-Nth calculation data SRDN may be included in the plurality of third calculation data SRDAT of FIG. 1. The fourth-first calculation data MCD1, the fourth-second calculation data MCD2 and the fourth-(N−1)th calculation data MCD(N−1) may be included in the plurality of fourth calculation data MCDAT of FIG. 1.

In some example embodiments, the XOR operation performed in operations S110, S240 and S330 may be referred to as a round key transformation function or an “AddRoundKey” function. The substitution operation performed in operations S210 and S310 may be referred to as an SBOX function or a “SubBytes” function. The row transformation operation performed in operations S220 and S320 may be referred to as a “ShiftRows” function. The column transformation operation performed in operation S230 may be referred to as a “MixColumns” function.

As described above, in the encryption process, one round may be completed when all of the “SubBytes” function, the “ShiftRows” function, the “MixColumns” function and the “AddRoundKey” function are executed. However, only the “AddRoundKey” function may be executed in the initial round, and only the “SubBytes” function, the “ShiftRows” function and the “AddRoundKey” function may be executed in the final round. A “KeyExpansion” function for generating the plurality of round key data RK may be executed.

In some example embodiments, all of the “SubBytes” function, the “ShiftRows” function, the “MixColumns” function and the “AddRoundKey” function that are executed during the encryption process may be a bijection, and thus each of such four functions may have an inverse function. Accordingly, a decryption process may be to inversely perform the inverse function of the functions.

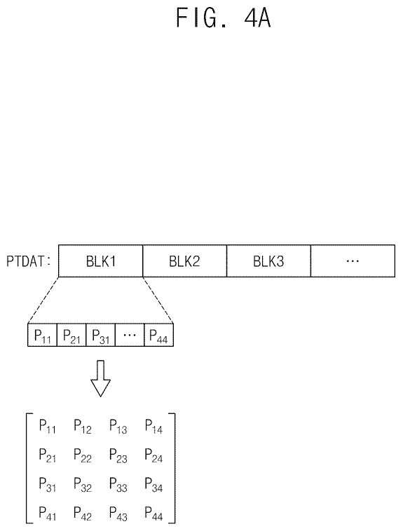

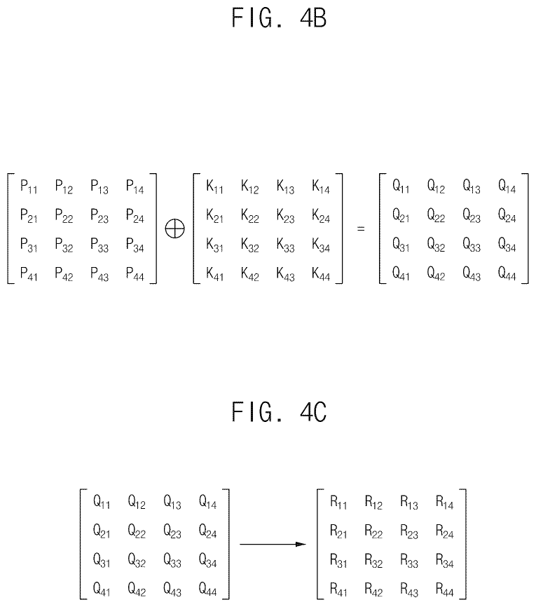

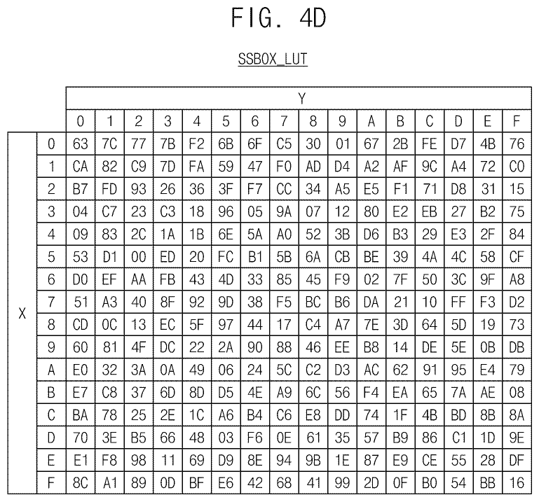

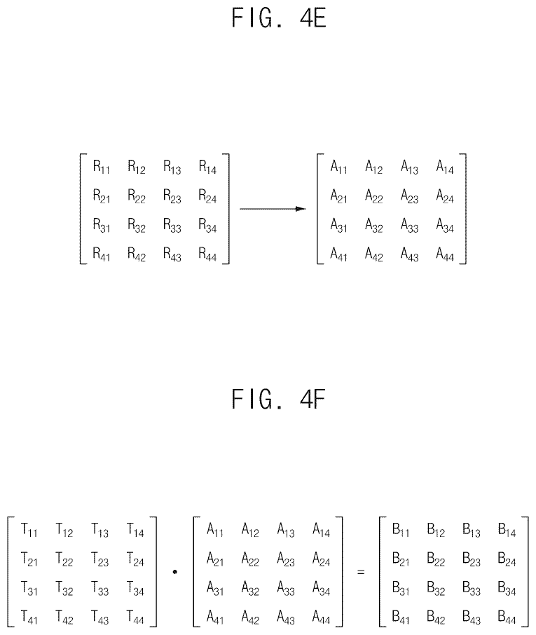

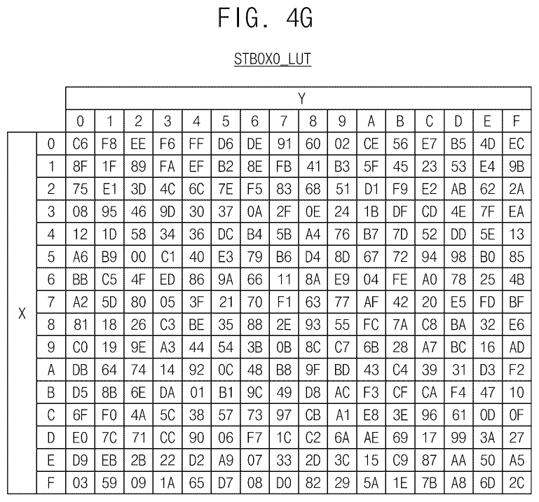

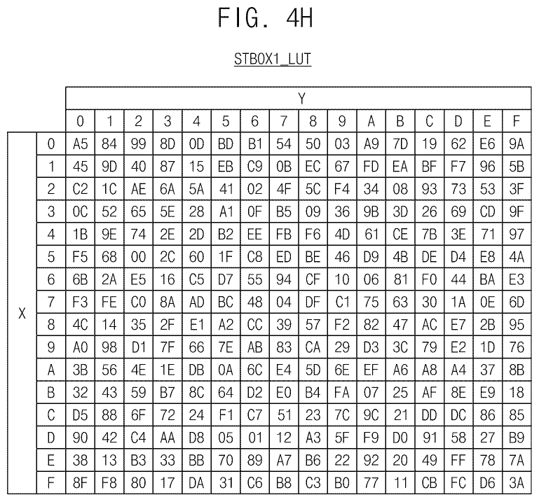

FIGS. 4A, 4B, 4C, 4D, 4E, 4F, 4G and 4H are diagrams for describing operations in FIGS. 1, 2, 3A, 3B, 3C, 3D and 3E.

Referring to FIG. 4A, an example of the plaintext data PTDAT that is input to the first calculator 110 is illustrated.

The plaintext data PTDAT may include a plurality of bits (or bytes). The plaintext data PTDAT may be divided into a plurality of blocks BLK1, BLK2, BLK3, . . . , and the encryption process may be performed by units of blocks (or on a block-by-block basis). In other words, the encryption process described with reference to FIG. 2 through 3E may be a block encryption process.

For example, if each round key data is data of 128 bits, each block may have a size of 128 bits or 16 bytes. Hereinafter, example embodiments will be described based on an example where each round key data is data of 128 bits. However, example embodiments are not limited thereto.

Each block (e.g., a block BLK1) may include sixteen sub-data P₁₁, P₂₁, P₃₁, P₄₁, P₁₂, P₂₂, P₃₂, P₄₂, P₁₃, P₂₃, P₃₃, P₄₃, P₁₄, P₂₄, P₃₄ and P₄₄, and each sub-data may have a size of 8 bits or 1 byte. Each block may be transformed into a 4×4 matrix, and the sixteen sub-data P₁₁, P₂₁, P₃₁, P₄₁, P₁₂, P₂₂, P₃₂, P₄₂, P₁₃, P₂₃, P₃₃, P₄₃, P₁₄, P₂₄, P₃₄ and P₄₄ may correspond to sixteen elements in the 4×4 matrix. A 4×4 sized matrix P that includes the sixteen elements P₁₁, P₂₁, P₃₁, P₄₁, P₁₂, P₂₂, P₃₂, P₄₂, P₁₃, P₂₃, P₃₃, P₄₃, P₁₄, P₂₄, P₃₄ and P₄₄ may be referred to as a state matrix.

Referring to FIG. 4B, an example of the XOR operation performed by the first calculator 110 is illustrated.

Since the block encryption process is performed as described above, the plaintext data PTDAT may be input as the 4×4 sized matrix P, and thus each round key data may also be provided as a 4×4 sized matrix K including sixteen elements: K₁₁, K₂₁, K₃₁, K₄₁, K₁₂, K₂₂, K₃₂, K₄₂, K₁₃, K₂₃, K₃₃, K₄₃, K₁₄, K₂₄, K₃₄ and K₄₄. The first calculator 110 may perform the XOR operation on each element of the matrix P and each element of the matrix K to output a 4×4 sized matrix Q including sixteen elements: Q₁₁, Q₂₁, Q₃₁, Q₄₁, Q₁₂, Q₂₂, Q₃₂, Q₄₂, Q₁₃, Q₂₃, Q₃₃, Q₄₃, Q₁₄, Q₂₄, Q₃₄ and Q₄₄. For example, each element of the matrix Q may be obtained based on Qᵢⱼ=Pᵢⱼ⊕Kᵢⱼ, where each of “i” and “j” are one, two, three and four, and where a symbol “⊕” denotes the XOR operation.

Referring to FIG. 4C, an example of the substitution operation performed by the second calculator 120 is illustrated.

The second calculator 120 may substitute the sixteen elements Q₁₁, Q₂₁, Q₃₁, Q₄₁, Q₁₂, Q₂₂, Q₃₂, Q₄₂, Q₁₃, Q₂₃, Q₃₃, Q₄₃, Q₁₄, Q₂₄, Q₃₄ and Q₄₄ included in the matrix Q for sixteen elements R₁₁, R₂₁, R₃₁, R₄₁, R₁₂, R₂₂, R₃₂, R₄₂, R₁₃, R₂₃, R₃₃, R₄₃, R₁₄, R₂₄, R₃₄ and R₄₄, respectively, using the SBOX 122 implemented based on the first corrected lookup table, and may output a 4×4 sized matrix R including the sixteen elements R₁₁, R₂₁, R₃₁, R₄₁, R₁₂, R₂₂, R₃₂, R₄₂, R₁₃, R₂₃, R₃₃, R₄₃, R₁₄, R₂₄, R₃₄ and R₄₄. For example, Qᵢⱼ may be replaced with Rᵢⱼ based on the first corrected lookup table, where each of “i” and “j” are one, two, three and four.

Referring to FIG. 4D, an example of a first standard lookup table SSBOX_LUT that is defined in the AES standard and used to implement the standard SBOX is illustrated.

For example, the first standard lookup table SSBOX_LUT may include a plurality of first standard elements, and each of the plurality of first standard elements may be expressed in hexadecimal and may have a size of 8 bits or 1 byte. For example, in the first standard lookup table SSBOX_LUT of FIG. 4D, a value X may represent upper four bits of an input value, and a value Y may represent lower four bits of the input value.

In a conventional AES encryptor, the substitution operation was performed using the standard SBOX implemented based on the first standard lookup table SSBOX_LUT. The substitution operation may be substantially the same as that described with reference to FIG. 4C.

For example, when the input value is “95” in hexadecimal, “9” may be selected as the X value and “5” may be selected as the Y value in the first standard lookup table SSBOX_LUT, and thus “2A” in hexadecimal may be obtained as an output value. In this manner, Rᵢⱼ=SSBOX(Qᵢⱼ) may be obtained, where each of “i” and “j” are one, two, three and four. SSBOX(Z) may represent the output value obtained when an input value Z is provided to the first standard lookup table SSBOX_LUT, and SSBOX(.) may denote a function for the first standard lookup table SSBOX_LUT.

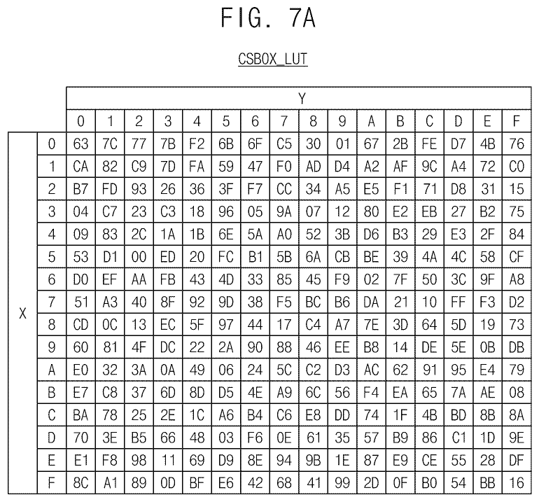

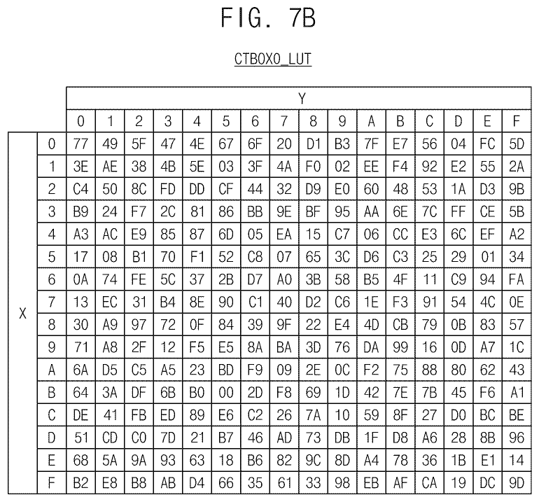

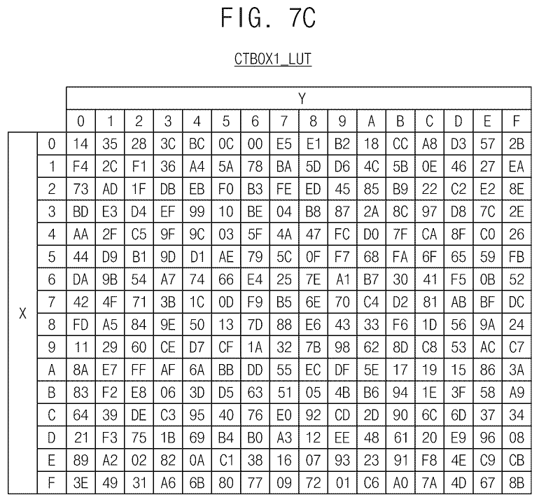

In some example embodiments, the first corrected lookup table may include a plurality of first corrected elements, and each of the plurality of first corrected elements may be obtained by performing the XOR operation on a respective one of the plurality of first standard elements included in the first standard lookup table SSBOX_LUT and a first value. The first corrected lookup table will be described with reference to FIG. 7A.

Referring to FIG. 4E, an example of the row transformation operation performed by the third calculator 130 is illustrated.

The third calculator 130 may perform the row transformation operation on the matrix Q to output a 4×4 sized matrix A including sixteen elements A₁₁, A₂₁, A₃₁, A₄₁, A₁₂, A₂₂, A₃₂, A₄₂, A₁₃, A₂₃, A₃₃, A₄₃, A₁₄, A₂₄, A₃₄ and A₄₄). For example, when the row transformation operation is performed, the elements R₁₁, R₁₂, R₁₃ and R₁₄ in a first row of the matrix Q may maintain their positions without shifting, the elements R₂₁, R₂₂, R₂₃ and R₂₄ in a second row of the matrix Q may be shifted to the left by one, the elements R₃₁, R₃₂, R₃₃ and R₃₄ in a third row of the matrix Q may be shifted to the left by two, and the elements R₄₁, R₄₂, R₄₃ and R₄₄ in a fourth row of the matrix Q may be shifted to the left by three. In other words, in the matrix A, the elements A₁₁, A₁₂, A₁₃ and A₁₄ in a first row may be obtained as A₁₁=R₁₁, A₁₂=R₁₂, A₁₃=R₁₃ and A₁₄=R₁₄, the elements A₂₁, A₂₂, A₂₃ and A₂₄ in a second row may be obtained as A₂₁=R₂₂, A₂₂=R₂₃, A₂₃=R₂₄ and A₂₄=R₂₁, the elements A₃₁, A₃₂, A₃₃ and A₃₄ in a third row may be obtained as A₃₁=R₃₃, A₃₂=R₃₄, A₃₃=R₃₁ and A₃₄=R₃₂, and the elements A₄₁, A₄₂, A₄₃ and A₄₄ in a fourth row may be obtained as A₄₁=R₄₄, A₄₂=R₄₁, A₄₃=R₄₂ and A₄₄=R₄₃.

Referring to FIG. 4F, an example of the column transformation operation performed by the fourth calculator 140 is illustrated.

The fourth calculator 140 may perform a matrix product calculation on a 4×4 sized matrix T including sixteen elements T₁₁, T₂₁, T₃₁, T₄₁, T₁₂, T₂₂, T₃₂, T₄₂, T₁₃, T₂₃, T₃₃, T₄₃, T₁₄, T₂₄, T₃₄ and T₄₄ and the matrix A, using the SBOX 142 and the at least one TBOX 144 implemented based on the at least one second corrected lookup table, and may output a 4×4 sized matrix B including sixteen elements B₁₁, B₂₁, B₃₁, B₄₁, B₁₂, B₂₂, B₃₂, B₄₂, B₁₃, B₂₃, B₃₃, B₄₃, B₁₄, B₂₄, B₃₄ and B₄₄. For example, such calculation may be an operation in the Galois field whose generator polynomial is (x⁸+x⁴+x³+x+1). For example, each element of the matrix B may be obtained based on Bᵢⱼ=Tᵢ₁A₁ⱼ⊕Tᵢ₂A₂ⱼ⊕Tᵢ₃A₃ⱼ⊕Tᵢ₄A₄ⱼ, where each of “i” and “j” are one, two, three and four, and where a symbol “⊕” denotes the XOR operation.

For example, in the matrix T, T₁₁=2, T₂₁=1, T₃₁=1, T₄₁=3, T₁₂=3, T₂₂=2, T₃₂=1, T₄₂=1, T₁₃=1, T₂₃=3, T₃₃=2, T₄₃=1, T₁₄=1, T₂₄=1, T₃₄=3 and T₄₄=2. In other words, the matrix T may be

$$T = [ \begin{matrix}2 & 3 & 1 & 1 \\ 1 & 2 & 3 & 1 \\ 1 & 1 & 2 & 3 \\ 3 & 1 & 1 & 2\end{matrix} ] ,$$

and {Tᵢ₁, Tᵢ₂, Tᵢ₃, Tᵢ₄}={1, 1, 2, 3}. To obtain all Bᵢⱼ, a calculation to multiply a specific element by two (e.g., a “×2” calculation) and a calculation to multiply a specific element by three (e.g., a “×3” calculation) may be required. Performing such multiplications may require a relatively long time.

FIGS. 4G and 4H illustrate an example of a second-first standard lookup table STBOX0_LUT and an example of a second-second standard lookup table STBOX1_LUT, which are defined to perform operations and/or calculations defined in the AES standard and are used to implement standard TBOXs, are illustrated. A configuration of the second-first standard lookup table STBOX0_LUT and a configuration of the second-second standard lookup table STBOX1_LUT may be similar to that of the first standard lookup table SSBOX_LUT.

In some example embodiments, the second-first standard lookup table STBOX0_LUT may include a plurality of second-first standard elements, and each of the plurality of second-first standard elements may be obtained by multiplying a respective one of the plurality of first standard elements included in the first standard lookup table SSBOX_LUT by two. In other words, STBOX0(Z)=2×SSBOX(Z). STBOX0(Z) may represent an output value obtained when an input value Z is provided to the second-first standard lookup table STBOX0_LUT, and STBOX0(.) may denote a function for the second-first standard lookup table STBOX0_LUT.

In some example embodiments, the second-second standard lookup table STBOX1_LUT may include a plurality of second-second standard elements, and each of the plurality of second-second standard elements may be obtained by multiplying a respective one of the plurality of first standard elements included in the first standard lookup table SSBOX_LUT by three. In other words, STBOX1(Z)=3×SSBOX(Z). STBOX1(Z) may represent an output value obtained when an input value Z is provided to the second-second standard lookup table STBOX1_LUT, and STBOX1(.) may denote a function for the second-second standard lookup table STBOX1_LUT.

In a conventional AES encryptor, the column transformation operation is performed using the standard SBOX implemented based on the first standard lookup table SSBOX_LUT of FIG. 4D, a first standard TBOX implemented based on the second-first standard lookup table STBOX0_LUT of FIG. 4G, and a second standard TBOX implemented based on the second-second standard lookup table STBOX1_LUT of FIG. 4H. Although such multiplications require a relatively long time as described above, calculation time may be reduced using such lookup tables.

For example, values of the elements of the matrix A may be equal to values of the elements of the matrix R, which are outputs of the standard SBOX. In other words, Aᵢⱼ=SSBOX(Sᵢⱼ), where each of “i” and “j” are one, two, three and four.

When the matrix T is implemented as described with reference to FIG. 4F, e.g., when one column of the T matrix includes two ones, a single two and a single three, each element of the matrix B may be obtained by performing the XOR operation on values obtained by multiplying two elements of the matrix A by one, a value obtained by multiplying one element of the matrix A by two, and a value obtained by multiplying one element of the matrix A by three. For example, B₁₂=2×A₁₂⊕3×A₂₂⊕1×A₃₂⊕1×A₄₂=2×SSBOX(S₁₂)⊕3×SSBOX(S₂₂)⊕SSBOX(S₃₂)⊕SSBOX(S₄₂), where a symbol “⊕” denotes the XOR operation. Since STBOX0(Z)=2×SSBOX(Z) and STBOX1(Z)=3×SSBOX(Z), B₁₂=STBOX0(S₁₂)⊕STBOX1(S₂₂)⊕SSBOX(S₃₂)⊕SSBOX(S₄₂), where a symbol “R” denotes the XOR operation.

In some example embodiments, the at least one second corrected lookup table may include a plurality of second corrected elements, and each of the plurality of second corrected elements may be obtained by performing the XOR operation on a respective one of the plurality of second standard elements included in the at least one second standard lookup table and a second value. For example, the second value may be different from the first value used to obtain the first corrected lookup table.

In some example embodiments, as will be described with reference to FIG. 5, the at least one second standard lookup table may include the second-first standard lookup table STBOX0_LUT and the second-second standard lookup table STBOX1_LUT. The at least one second corrected lookup table may include a second-first corrected lookup table that is obtained by performing the XOR operation based on the second-first standard lookup table STBOX0_LUT, and a second-second corrected lookup table that is obtained by performing the XOR operation based on the second-second standard lookup table STBOX1_LUT. The second-first corrected lookup table may include a plurality of second-first corrected elements, and each of the plurality of second-first corrected elements may be obtained by performing the XOR operation on a respective one of the plurality of second-first standard elements included in the second-first standard lookup table STBOX0_LUT and the second value. The second-second corrected lookup table may include a plurality of second-second corrected elements, and each of the plurality of second-second corrected elements may be obtained by performing the XOR operation on a respective one of the plurality of second-second standard elements included in the second-second standard lookup table STBOX1_LUT and the second value. The second-first corrected lookup table and the second-second corrected lookup table will be described with reference to FIGS. 7B and 7C.

In some example embodiments, as will be described with reference to FIG. 8, the at least one second standard lookup table may include only the second-first standard lookup table STBOX0_LUT. The at least one second corrected lookup table may include only the second-first corrected lookup table that is obtained by performing the XOR operation based on the second-first standard lookup table. The second-first corrected lookup table may include a plurality of second-first corrected elements, and each of the plurality of second-first corrected elements may be obtained by performing the XOR operation on a respective one of the plurality of second-first standard elements included in the second-first standard lookup table STBOX0_LUT and the second value.

As described above, a conventional AES encryptor operates using the standard SBOX, which is implemented based on the first standard lookup table SSBOX_LUT of FIG. 4D, the first standard TBOX implemented based on the second-first standard lookup table STBOX0_LUT of FIG. 4G, and the second standard TBOX implemented based on the second-second standard lookup table STBOX1_LUT of FIG. 4H. Recently, with the increasing high speed and large capacity of electronic devices, AES encryptors are required to have low latency and high throughput. To meet these performance demans, it may be necessary to increase a clock frequency and minimize the number of logic gates in the hardware configuration.

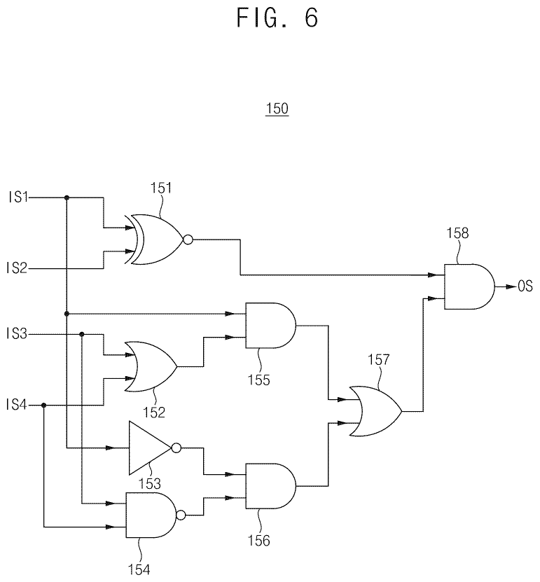

FIG. 5 is a block diagram illustrating an example of a fourth calculator included in an encryptor according to example embodiments. FIG. 6 is a diagram for describing a logic depth of an SBOX and a TBOX included in a fourth calculator of FIG. 5.

Referring to FIG. 5, a fourth calculator 140a may include an SBOX 142a, at least one TBOX 144a and an XOR calculator 148a. The at least one TBOX 144a may include a first TBOX 145a and a second TBOX 146a.

The SBOX 142a may be implemented based on the first corrected lookup table that is converted from the first standard lookup table SSBOX_LUT, and may be implemented as hardware including a plurality of logic gates. Since the operating speed is slow when the SBOX is implemented by directly mapping input/output values by storing and using the lookup table, the SBOX 142a may be implemented in the form of hardware.

In some example embodiments, each of the plurality of first corrected elements included in the first corrected lookup table may be obtained by performing the XOR operation on a respective one of the plurality of first standard elements included in the first standard lookup table SSBOX_LUT and a first value L. In other words, the SBOX 142a according to example embodiments may be implemented so as to satisfy CSBOX(Z)=SSBOX(Z)⊕L, where a symbol “⊕” denotes the XOR operation.

The first TBOX 145a may be implemented based on the second-first corrected lookup table that is converted from the second-first standard lookup table STBOX0_LUT, and may be implemented as hardware including a plurality of logic gates. The second TBOX 146a may be implemented based on the second-second corrected lookup table that is converted from the second-second standard lookup table STBOX1_LUT, and may be implemented as hardware including a plurality of logic gates. As with the SBOX 142a, each of the first and second TBOXs 145a and 146a may also be implemented in the form of hardware.

In some example embodiments, each of the plurality of second-first corrected elements included in the second-first corrected lookup table may be obtained by performing the XOR operation on a respective one of the plurality of second-first standard elements included in the second-first standard lookup table STBOX0_LUT and a second value K. In other words, the first TBOX 145a according to example embodiments may be implemented so as to satisfy CTBOX0(Z)=STBOX0(Z)⊕K, where a symbol “⊕” denotes the XOR operation.

In some example embodiments, each of the plurality of second-second corrected elements included in the second-second corrected lookup table may be obtained by performing the XOR operation on a respective one of the plurality of second-second standard elements included in the second-second standard lookup table STBOX1_LUT and the second value K. In other words, the second TBOX 146a according to example embodiments may be implemented so as to satisfy CTBOX1(Z)=STBOX1(Z)⊕K, where a symbol “⊕” denotes the XOR operation.

The XOR calculator 148a may generate one element BSa included in the matrix B based on (e.g., by performing the XOR operation on) two elements SBL1a and SBL2a among the plurality of first corrected elements that are provided from the SBOX 142a and included in the first corrected lookup table, one element TBK0a among the plurality of second-first corrected elements that are provided from the first TBOX 145a and included in the second-first corrected lookup table, and one element TBK1a among the plurality of second-second corrected elements that are provided from the second TBOX 146a and included in the second-second corrected lookup table. For example, B₁₂=CTBOX0(S₁₂)⊕CTBOX1(S₂₂)⊕CSBOX(S₃₂)⊕CSBOX(S₄₂), where a symbol “⊕” denotes the XOR operation.

In a case according to the conventional scheme where the column transformation operation is performed using the standard SBOX implemented based on the first standard lookup table SSBOX_LUT of FIG. 4D, the first standard TBOX implemented based on the second-first standard lookup table STBOX0_LUT of FIG. 4D, and the second standard TBOX implemented based on the second-second standard lookup table STBOX1_LUT of FIG. 4H,

B₁₂=STBOX0(S₁₂)⊕STBOX1(S₂₂)⊕SSBOX(S₃₂)⊕SSBOX (S₄₂), where a symbol “⊕” denotes the XOR operation. In a case according to example embodiments where the column transformation operation is performed using the SBOX 142a implemented based on the first corrected lookup table converted from the first standard lookup table SSBOX_LUT, the first TBOX 145a implemented based on the second-first corrected lookup table converted from the second-first standard lookup table STBOX0_LUT, and the second TBOX 146a implemented based on the second-second corrected lookup table converted from the second-second standard lookup table STBOX1_LUT, B₁₂=CTBOX0(S₁₂)⊕CTBOX1(S₂₂)⊕CSBOX(S₃₂)⊕CSBOX(S₄₂), where a symbol “⊕” denotes the XOR operation. Although the mathematical formulas are similar in both cases, the configurations of the lookup tables are different in both cases, and therefore, configurations of logic gates of the SBOX 142a and the TBOXs 145a and 146a according to example embodiments may be different from configurations of logic gates of the standard SBOX and the standard TBOXs.

In some example embodiments, the first value L and the second value K may be determined such that the logic depth of each of the SBOX 142a and the TBOXs 145a and 146a is minimized. In other words, the first value L and the second value K may be determined or set so as to satisfy

$$arg {min}_{K , L ∈ {Z}_{2}^{8}}$$

(max depth (CTBOX0, CTBOX1, CSBOX)).

Referring to FIG. 6, an example of a circuit 150, which generates an output signal OS based on input signals IS1, IS2, IS3 and IS4 and includes a plurality of logic gates 151, 152, 153, 154, 155, 156, 157 and 158, is illustrated.

A logic depth of the circuit 150 may refer to the number of logic gates (or operations) that need to be applied in sequence to perform the cryptographic operation. For example, the logic depth may represent the maximum number of logic gates that an input signal (e.g., each of the input signals IS1, IS2, IS3 and IS4) passes through until an output signal OS is generated. For example, the circuit 150 may include four signal paths including a first path passing through two logic gates 151 and 158, a second path passing through four logic gates 152, 155, 157 and 158, a third path passing through four logic gates 153, 156, 157 and 158, and a fourth path passing through four logic gates 154, 156, 157 and 158. Since the number of logic gates in the first path is two and the number of logic gates of each of the second, third and fourth paths is four, the logic depth of the circuit 150 may be four.

When the first value L and the second value K are determined such that the logic depth of the SBOX 142a, the logic depth of the first TBOX 145a and the logic depth of the second TBOX 146a are minimized, the encryptor according to example embodiments may achieve low-latency characteristics. For example, when the first value Lis “00” in hexadecimal and the second value K is “B1” in hexadecimal, it can be seen that the encryptor according to example embodiments operates at a clock frequency of about 1 GHz, which may be a higher frequency than a clock frequency of about 800 MHz when using conventional standard SBOX and conventional standard TBOXs. However, example embodiments are not limited thereto.

FIGS. 7A, 7B and 7C are diagrams for describing an SBOX, a first TBOX and a second TBOX included in a fourth calculator of FIG. 5.

Referring to FIG. 7A, an example of a first corrected lookup table CSBOX_LUT that is used to implement the SBOX 142a is illustrated. For example, when the first value L is “00” in hexadecimal as described above, the plurality of first corrected elements included in the first corrected lookup table CSBOX_LUT may be obtained by performing the XOR operation on the plurality of first standard elements included in the first standard lookup table SSBOX_LUT and “00”. For example, when the first value L is “00” in hexadecimal, the first corrected lookup table CSBOX_LUT may be substantially identical to the first standard lookup table SSBOX_LUT.

Referring to FIG. 7B, an example of a second-first corrected lookup table CTBOX0_LUT that is used to implement the first TBOX 145a is illustrated. For example, when the second value K is “B1” in hexadecimal as described above, the plurality of second-first corrected elements included in the second-first corrected lookup table CTBOX0_LUT may be obtained by performing the XOR operation on the plurality of second-first standard elements included in the second-first standard lookup table STBOX0_LUT and “B1”.

Referring to FIG. 7C, an example of a second-second corrected lookup table CTBOX1_LUT that is used to implement the second TBOX 146a is illustrated. For example, when the second value K is “B1” in hexadecimal as described above, the plurality of second-second corrected elements included in the second-second corrected lookup table CTBOX1_LUT may be obtained by performing an XOR operation on the plurality of second-second standard elements included in the second-second standard lookup table STBOX1_LUT and “B1”.

However, example embodiments are not limited to the first corrected lookup table CSBOX_LUT of FIG. 7A, the second-first corrected lookup table CTBOX0_LUT of FIG. 7B and the second-second corrected lookup table CTBOX1_LUT of FIG. 7C. As described above, the first value L and the second value K may be changed according to example embodiments and may be determined as optimal values according to example embodiments, and therefore, the corrected lookup tables obtained based on the first value L and the second value K and the SBOXs and TBOXs implemented using the corrected lookup tables may be variously implemented according to example embodiments.

FIG. 8 is a block diagram illustrating an example of a fourth calculator included in an encryptor according to example embodiments. The descriptions repeated with or overlapping with descriptions of FIG. 5 will be omitted in the interest of brevity.

Referring to FIG. 8, a fourth calculator 140b may include an SBOX 142b, at least one TBOX 144b and an XOR calculator 148b. The at least one TBOX 144b may include a first TBOX 145b.

The SBOX 142b may be implemented based on the first corrected lookup table that is converted from the first standard lookup table SSBOX_LUT, and may be implemented with hardware including a plurality of logic gates. The first TBOX 145b may be implemented based on the second-first corrected lookup table that is converted from the second-first standard lookup table STBOX0_LUT, and may be implemented with hardware including a plurality of logic gates. Since CTBOX1(Z)=CTBOX0(Z)⊕CSBOX(Z), the fourth calculator 140b may be implemented using only the first TBOX 145b.

In some example embodiments, the SBOX 142b according to example embodiments may be implemented so as to satisfy CSBOX(Z)=SSBOX(Z)⊕L′, and the first TBOX 145b according to example embodiments may be implemented so as to satisfy CTBOX0(Z)=STBOX0(Z)⊕K′. In this example, a first value L′ and a second value K′ in an example of FIG. 8 may be different from the first value L and the second value K in the example of FIG. 5.

The XOR calculator 148b may generate one element BSb included in the matrix B based on (e.g., by performing the XOR operation on) three elements SBL1b SBL2b and SBL3b among the plurality of first corrected elements that are provided from the SBOX 142b and included in the first corrected lookup table, and two elements TBK01b and TBK02b among the plurality of second-first corrected elements that are provided from the first TBOX 145b and included in the second-first corrected lookup table. For example, B₁₂=CTBOX0(S₁₂)⊕CTBOX0(S₂₂)⊕CSBOX(S₂₂)⊕CSBOX(S₃₂)⊕CSBOX(S₄₂), where a symbol “⊕” denotes the XOR operation.

As compared to the example of FIG. 5 where the at least one TBOX 144a includes both the first and second TBOXs 145a and 146a, in the example of FIG. 8 where the at least one TBOX 144b includes only the first TBOX 145b, the total number of logic gates included in the encryptor may be reduced, however, the latency may increase because one XOR operation is additionally performed during the column transformation operation.

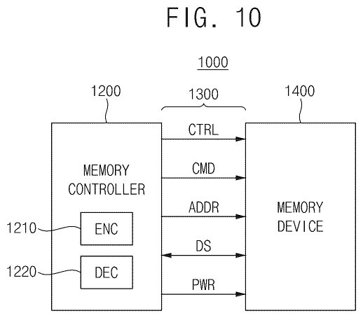

FIG. 9 is a flowchart illustrating a method of designing an encryptor according to example embodiments.

Referring to FIGS. 1 and 9, a method of designing an encryptor according to example embodiments is disclosed. The encryptor 100 includes the first calculator 110 configured to perform the XOR operation, the second calculator 120 configured to perform the substitution operation, the third calculator 130 configured to perform the row transformation operation, and the fourth calculator 140 configured to perform the column transformation operation (operation S1100). The second and fourth calculators 120 and 140 are modified or changed such that the logic depth of each of the SBOXs 122 and 142 included in the second and fourth calculators 120 and 140 and the logic depth of each of the at least one TBOX 144 included in the fourth calculator 140 are minimized (operation S1200). For example, the SBOX, the TBOXs and the lookup tables related thereto may be modified as described with reference to FIGS. 1 through 8.

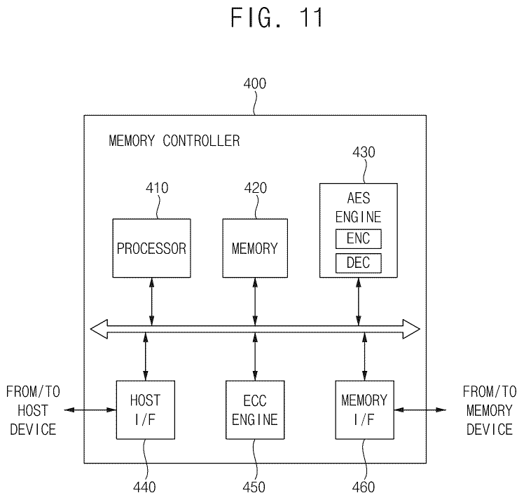

FIG. 10 is a block diagram illustrating a memory controller and a memory system including the memory controller according to example embodiments.

Referring to FIG. 10, a memory system 1000 includes a memory controller 1200 and a memory device 1400. The memory system 1000 may further include a plurality of signal lines 1300 that electrically connect the memory controller 1200 with the memory device 1400.

The memory device 1400 is controlled by the memory controller 1200. For example, based on requests from a host device, the memory controller 1200 may store (e.g., write or program) data into the memory device 1400, or may retrieve (e.g., read or sense) data from the memory device 1400. The memory controller 1200 may include an encryptor (ENC) 1210 and a decryptor (DEC) 1220 that are implemented according to embodiments of the present disclosure.

The plurality of signal lines 1300 may include control lines, command lines, address lines, data input/output (I/O) lines and power lines. The memory controller 1200 may transmit a command CMD, an address ADDR and a control signal CTRL to the memory device 1400 via the command lines, the address lines and the control lines, may exchange a data signal DS with the memory device 1400 via the data I/O lines, and may transmit a power supply voltage PWR to the memory device 1400 via the power lines. The plurality of signal lines 1300 may further include data strobe signal (DQS) lines for transmitting a DQS signal.

FIG. 11 is a block diagram illustrating a memory controller according to example embodiments.

Referring to FIG. 11, a memory controller 400 may include a processor 410, a memory 420, an advanced encryption standard (AES) engine 430, a host interface (I/F) 440, an error correction code (ECC) engine 450 and a memory interface 460.

The processor 410 may control an operation of the memory controller 400 in response to a request received via the host interface 440 from a host device. For example, the processor 410 may control an operation of a memory system (e.g., the memory system 1000 in FIG. 10), and may control respective components by employing firmware for operating a memory device (e.g., the memory device 1400 in FIG. 10).

The memory 420 may store instructions and data that are executed and processed by the processor 410. For example, the memory 420 may be a buffer memory that temporarily stores the instructions and the data. For example, the memory 420 may be implemented with a volatile memory, such as a dynamic random access memory (DRAM), a static random access memory (SRAM), a cache memory, or the like.

The AES engine 430 may perform at least one of an encryption operation and a decryption operation on data that is input to and/or output from the memory controller 400 using a symmetric-key algorithm. For example, the AES engine 430 may include an encryptor ENC and a decryptor DEC. The encryptor ENC may be the encryptor according to example embodiments, and may perform the encryption operation on first data, which is plaintext data, received from the memory 420. The decryptor DEC may be a decryptor corresponding to the encryptor according to example embodiments, and may perform the decryption operation on second data, which is ciphertext data, received from the memory 420. For example, the encryptor ENC and the decryptor DEC may be implemented based on AES standard, with modifications made according to the embodiments of the present disclosure. For example, the encryptor ENC and the decryptor DEC may be implemented as separate modules. For example, one module capable of performing both the encryption and decryption operations may be implemented in the AES engine 470.

The ECC engine 450 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The host interface 440 may provide physical connections between the host device and the memory device. The host interface 440 may provide an interface corresponding to a bus format of the host device for communication between the host device and the memory device. In some example embodiments, the bus format of the host device may be a small computer system interface (SCSI) or a serial attached SCSI (SAS) interface. In other example embodiments, the bus format of the host device may be a universal serial bus (USB), a peripheral component interconnect (PCI) express (PCIe), an advanced technology attachment (ATA), a parallel ATA (PATA), a serial ATA (SATA), a nonvolatile memory (NVM) express (NVMe), a compute express link (CXL), etc., format.

The memory interface 460 may exchange data with the memory device. The memory interface 460 may transfer data to the memory device, or may receive data read from the memory device. In some example embodiments, the memory interface 460 may be connected to the memory device via one channel. In other example embodiments, the memory interface 460 may be connected to the memory device via two or more channels. For example, the memory interface 460 may be configured to comply with a standard protocol, such as Toggle or open NAND flash interface (ONFI).

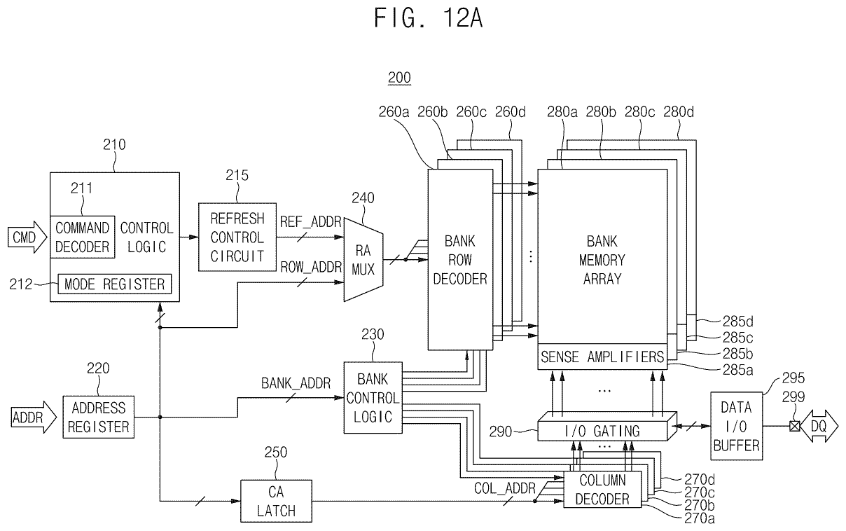

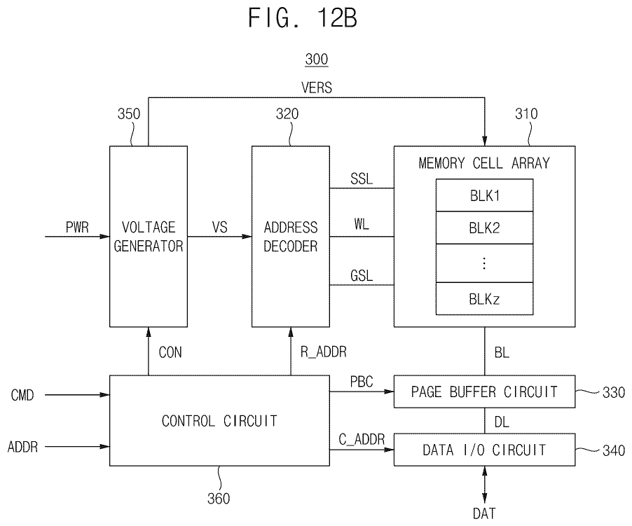

FIGS. 12A and 12B are block diagrams illustrating examples of a memory device that is controlled by a memory controller according to example embodiments.

Referring to FIG. 12A, a memory device 200 may include a control logic 210, a refresh control circuit 215, an address register 220, a bank control logic 230, a row address multiplexer 240, a column address latch 250, a row decoder, a column decoder, a memory cell array, a sense amplifier unit, an input/output (I/O) gating circuit 290, a data I/O buffer 295 and a data I/O pad 299. For example, a memory device 200 may be one of various volatile memories such as a DRAM.

The memory cell array may include a plurality of memory cells. The memory cell array may include a plurality of bank arrays, e.g., first to fourth bank arrays 280a, 280b, 280c and 280d. The row decoder may include a plurality of bank row decoders, e.g., first to fourth bank row decoders 260a, 260b, 260c and 260d connected to the first to fourth bank arrays 280a, 280b, 280c and 280d, respectively. The column decoder may include a plurality of bank column decoders, e.g., first to fourth bank column decoders 270a, 270b, 270c and 270d connected to the first to fourth bank arrays 280a, 280b, 280c and 280d, respectively. The sense amplifier unit may include a plurality of bank sense amplifiers, e.g., first to fourth bank sense amplifiers 285a, 285b, 285c and 285d connected to the first to fourth bank arrays 280a, 280b, 280c and 280d, respectively.

The first to fourth bank arrays 280a to 280d, the first to fourth bank row decoders 260a to 260d, the first to fourth bank column decoders 270a to 270d, and the first to fourth bank sense amplifiers 285a to 285d may form first to fourth banks, respectively. For example, the first bank array 280a, the first bank row decoder 260a, the first bank column decoder 270a, and the first bank sense amplifier 285a may form the first bank; the second bank array 280b, the second bank row decoder 260b, the second bank column decoder 270b, and the second bank sense amplifier 285b may form the second bank; the third bank array 280c, the third bank row decoder 260c, the third bank column decoder 270c, and the third bank sense amplifier 285c may form the third bank; and the fourth bank array 280d, the fourth bank row decoder 260d, the fourth bank column decoder 270d, and the fourth bank sense amplifier 285d may form the fourth bank.

The address register 220 may receive an address ADDR including a bank address BANK_ADDR, a row address ROW_ADDR and a column address COL_ADDR from a memory controller (e.g., the memory controller 1200 in FIG. 10) located outside the memory device 200. The address register 220 may provide the received bank address BANK_ADDR to the bank control logic 230, may provide the received row address ROW_ADDR to the row address multiplexer 240, and may provide the received column address COL_ADDR to the column address latch 250.

The bank control logic 230 may generate bank control signals in response to receipt of the bank address BANK_ADDR. One of the first to fourth bank row decoders 260a to 260d corresponding to the received bank address BANK_ADDR may be activated in response to the bank control signals generated by the bank control logic 230, and one of the first to fourth bank column decoders 270a to 270d corresponding to the received bank address BANK_ADDR may be activated in response to the bank control signals generated by the bank control logic 230.

The refresh control circuit 215 may generate a refresh address REF_ADDR in response to receipt of a refresh command or entrance of any self-refresh mode. For example, the refresh control circuit 215 may include a refresh counter that is configured to sequentially change the refresh address REF_ADDR from a first address of the memory cell array to a last address of the memory cell array. The refresh control circuit 215 may receive control signals from the control logic 210.

The row address multiplexer 240 may receive the row address ROW_ADDR from the address register 220, and may receive the refresh address REF_ADDR from the refresh control circuit 215. The row address multiplexer 240 may selectively output the row address ROW_ADDR or the refresh address REF_ADDR. A row address (e.g., the row address ROW_ADDR or the refresh address REF_ADDR) output from the row address multiplexer 240 may be applied to the first to fourth bank row decoders 260a to 260d.

The activated one of the first to fourth bank row decoders 260a to 260d may decode the row address output from the row address multiplexer 240, and may activate a wordline corresponding to the row address. For example, the activated bank row decoder may apply a wordline driving voltage to the wordline corresponding to the row address.

The column address latch 250 may receive the column address COL_ADDR from the address register 220, and may temporarily store the received column address COL_ADDR. The column address latch 250 may apply the temporarily stored or received column address COL_ADDR to the first to fourth bank column decoders 270a to 270d.

The activated one of the first to fourth bank column decoders 270a to 270d may decode the column address COL_ADDR output from the column address latch 250, and may control the I/O gating circuit 290 to output data corresponding to the column address COL_ADDR.

The I/O gating circuit 290 may include a circuitry for gating I/O data. For example, the I/O gating circuit 290 may include an input data mask logic, read data latches for storing data output from the first to fourth bank arrays 280a to 280d, and write drivers for writing data to the first to fourth bank arrays 280a to 280d.

Data DQ to be read from one of the first to fourth bank arrays 280a to 280d may be sensed by a sense amplifier coupled to the one bank array, and may be stored in the read data latches. The data DQ stored in the read data latches may be provided to the memory controller via the data I/O buffer 295 and the data I/O pad 299. Data DQ received via the data I/O pad 299 that are to be written to one of the first to fourth bank arrays 280a to 280d may be provided from the memory controller to the data I/O buffer 295. The data DQ received via the data I/O pad 299 and provided to the data I/O buffer 295 may be written to the one bank array via the write drivers in the I/O gating circuit 290.

The control logic 210 may control an operation of the memory device 200. For example, the control logic 210 may generate control signals for the memory device 200 to perform a data write operation or a data read operation. The control logic 210 may include a command decoder 211 that decodes a command CMD received from the memory controller, and a mode register 212 that sets an operation mode of the memory device 200. For example, the command decoder 211 may generate the control signals corresponding to the command CMD by decoding a write enable signal, a row address strobe signal, a column address strobe signal, a chip selection signal, etc.

Referring to FIG. 12B, a memory device 300 may include a memory cell array 310, an address decoder 320, a page buffer circuit 330, a data input/output (I/O) circuit 340, a voltage generator 350 and a control circuit 360. For example, a memory device 300 may be one of various nonvolatile memories such as a NAND flash memory.

The memory cell array 310 may be connected to the address decoder 320 via a plurality of string selection lines SSL, a plurality of wordlines WL and a plurality of ground selection lines GSL. The memory cell array 310 may be further connected to the page buffer circuit 330 via a plurality of bitlines BL. The memory cell array 310 may include a plurality of memory cells (e.g., a plurality of nonvolatile memory cells) that are connected to the plurality of wordlines WL and the plurality of bitlines BL. The memory cell array 310 may be divided into a plurality of memory blocks BLK1, BLK2, . . . , BLKz each of which includes memory cells.

In some example embodiments, the plurality of memory cells may be arranged in a two-dimensional (2D) array structure or a three-dimensional (3D) vertical array structure. A three-dimensional vertical array structure may include vertical cell strings that are vertically oriented such that at least one memory cell is located over another memory cell. The at least one memory cell may comprise a charge trap layer. A memory cell array including a 3D vertical array structure, may be configured into a plurality of levels, with wordlines and/or bitlines shared between the levels.

The control circuit 360 may receive a command CMD and an address ADDR from a memory controller (e.g., the memory controller 1200 in FIG. 10) located outside the memory device 300, and may control erasure, programming and read operations of the memory device 300 based on the command CMD and the address ADDR. An erasure operation may include performing a sequence of erase loops, and a programming operation may include performing a sequence of program loops. Each program loop may include a program operation and a program verification operation. Each erase loop may include an erase operation and an erase verification operation. The read operation may include a normal read operation and data recovery read operation.

For example, the control circuit 360 may generate control signals CON, which are used for controlling the voltage generator 350, and may generate control signal PBC for controlling the page buffer circuit 330, based on the command CMD, and may generate a row address R_ADDR and a column address C_ADDR based on the address ADDR. The control circuit 360 may provide the row address R_ADDR to the address decoder 320 and may provide the column address C_ADDR to the data I/O circuit 340.

The address decoder 320 may be connected to the memory cell array 310 via the plurality of string selection lines SSL, the plurality of wordlines WL and the plurality of ground selection lines GSL. For example, in the data erase/write/read operations, the address decoder 320 may determine at least one of the plurality of wordlines WL as a selected wordline, at least one of the plurality of string selection lines SSL as a selected string selection line, and at least one of the plurality of ground selection lines GSL as a selected ground selection line, based on the row address R_ADDR.

The voltage generator 350 may generate voltages VS that are required for an operation of the memory device 300 based on a power PWR and the control signals CON. The voltages VS may be applied to the plurality of string selection lines SSL, the plurality of wordlines WL and the plurality of ground selection lines GSL via the address decoder 320. In addition, the voltage generator 350 may generate an erase voltage VERS that is required for the erase operation based on the power PWR and the control signals CON.

The page buffer circuit 330 may be connected to the memory cell array 310 via the plurality of bitlines BL. The page buffer circuit 330 may include a plurality of page buffers. The page buffer circuit 330 may store data DAT to be programmed into the memory cell array 310 or may read data DAT sensed from the memory cell array 310. In other words, the page buffer circuit 330 may operate as a write driver or a sensing amplifier according to an operation mode of the memory device 300.

The data I/O circuit 340 may be connected to the page buffer circuit 330 via data lines DL. The data I/O circuit 340 may provide the data DAT from the outside of the memory device 300 to the memory cell array 310 via the page buffer circuit 330 or may provide the data DAT from the memory cell array 310 to the outside of the memory device 300, based on the column address C_ADDR.

Although the memory device according to example embodiments is described based on a DRAM and a NAND flash memory, the memory device according to example embodiments may be or include any volatile memory, and/or any nonvolatile memory, e.g., a static random access memory (SRAM), a phase-change random access memory (PRAM), a resistive random access memory (RRAM), a magnetic random access memory (MRAM), a ferroelectric random access memory (FRAM), etc.

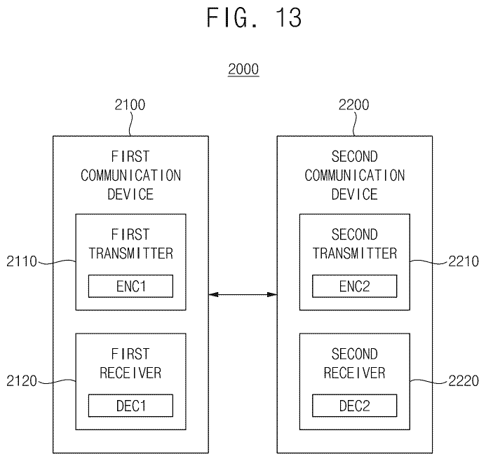

FIG. 13 is a block diagram illustrating an electronic system including an encryptor according to example embodiments.

Referring to FIG. 13, an electronic system 2000 includes a first communication device 2100 and a second communication device 2200. The first communication device 2100 and the second communication device 2200 may exchange signals through a wired channel and/or a wireless channel.

The first communication device 2100 includes a first transmitter 2110 and a first receiver 2120. The second communication device 2200 includes a second transmitter 2210 and a second receiver 2220. The first transmitter 2110 and the first receiver 2120 may be connected with the second transmitter 2210 and the second receiver 2220 via the wired channel and/or the wireless channel. In some example embodiments, each of the first and second communication devices 2100 and 2200 may include a plurality of transmitters a plurality of receivers, and may include a plurality of channels for connecting the plurality of transmitters and the plurality of receivers with one another.

The first transmitter 2110 may include a first encryptor ENC1, and the first receiver 2120 may include a first decryptor DEC1. The second transmitter 2210 may include a second encryptor ENC2, and the second receiver 2220 may include a second decryptor DEC2. Each of the encryptors ENC1 and ENC2 may be the encryptor according to example embodiments, and each of the decryptors DEC1 and DEC2 may be a decryptor corresponding to the encryptor according to example embodiments.

The example embodiments may be applied to various electronic devices and systems that include the encryptors. For example, the example embodiments may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A processor configured to:
perform an XOR operation on plaintext data based on one of a plurality of round key data to obtain a first calculation output;
perform a substitution operation on the first calculation output using a substitution box (SBOX) that is implemented based on a first corrected lookup table converted from a first standard lookup table, to obtain a second calculation output;
perform a row transformation operation on the second calculation output to obtain a third calculation output;
perform a column transformation operation on the third calculation output using the SBOX and a transformation box (TBOX) that is implemented based on a second corrected lookup table converted from a second standard lookup table, to obtain a fourth calculation output; and
obtain ciphertext data based on the third calculation output and the fourth calculation output.

2. The processor of claim 1, wherein the processor is further configured to:
obtain the first corrected lookup table by performing the XOR operation based on the first standard lookup table, and
obtain the second corrected lookup table by performing the XOR operation based on the second standard lookup table.

3. The processor of claim 2, wherein:
the first standard lookup table comprises a plurality of first standard elements, and the first corrected lookup table comprises a plurality of first corrected elements,
each of the plurality of first corrected elements is obtained by performing the XOR operation on a respective one of the plurality of first standard elements and a first value,
the second standard lookup table comprises a plurality of second standard elements, and the second corrected lookup table comprises a plurality of second corrected elements, and
each of the plurality of second corrected elements is obtained by performing the XOR operation on a respective one of the plurality of second standard elements and a second value.

4. The processor of claim 3, wherein each of the SBOX and the TBOX is implemented in hardware that comprises a plurality of logic gates.

5. The processor of claim 4, wherein:
the first value and the second value are determined such that a logic depth of each of the SBOX and the TBOX is minimized, and
the logic depth represents a maximum number of logic gates through which an input signal passes until an output signal is generated based on the input signal.

6. The processor of claim 3, wherein the first value is different from the second value.

7. The processor of claim 1, wherein:
the second standard lookup table comprises a second-first standard lookup table and a second-second standard lookup table,
the second corrected lookup table comprises a second-first corrected lookup table that is obtained by performing the XOR operation based on the second-first standard lookup table, and a second-second corrected lookup table that is obtained by performing the XOR operation based on the second-second standard lookup table, and
the TBOX comprises a first TBOX that is implemented based on the second-first corrected lookup table, and a second TBOX that is implemented based on the second-second corrected lookup table.

8. The processor of claim 7, wherein:
the first corrected lookup table comprises a plurality of first corrected elements, the second-first corrected lookup table comprises a plurality of second-first corrected elements, and the second-second corrected lookup table comprises a plurality of second-second corrected elements,
the processor is further configured to output the fourth calculation output that comprises a plurality of elements, and
one of the plurality of elements in the fourth calculation output is obtained based on two of the plurality of first corrected elements, one of the plurality of second-first corrected elements and one of the plurality of second-second corrected elements.

9. The processor of claim 8, wherein the processor is further configured to:
perform the XOR operation based on the two of the plurality of first corrected elements, the one of the plurality of second-first corrected elements and the one of the plurality of second-second corrected elements.

10. The processor of claim 7, wherein:
the first standard lookup table comprises a plurality of first standard elements, the second-first standard lookup table comprises a plurality of second-first standard elements, and the second-second standard lookup table comprises a plurality of second-second standard elements,
each of the plurality of second-first standard elements is obtained by multiplying a respective one of the plurality of first standard elements by two, and
each of the plurality of second-second standard elements is obtained by multiplying a respective one of the plurality of first standard elements by three.

11. The processor of claim 1, wherein:
the second standard lookup table comprises a second-first standard lookup table,
the second corrected lookup table comprises a second-first corrected lookup table that is obtained by performing the XOR operation based on the second-first standard lookup table, and
the TBOX comprises a first TBOX that is implemented based on the second-first corrected lookup table.

12. The processor of claim 11, wherein:
the first corrected lookup table comprises a plurality of first corrected elements, and the second-first corrected lookup table comprises a plurality of second-first corrected elements,
the processor is further configured to output the fourth calculation output that comprises a plurality of elements, and
one of the plurality of elements in the fourth calculation output is obtained based on three of the plurality of first corrected elements and two of the plurality of second-first corrected elements.

13. The processor of claim 1, wherein the ciphertext data is obtained through a plurality of operation rounds:
the plurality of operation rounds comprises an initial round and first to Nth rounds, where N is a positive integer greater than or equal to two, and
the plurality of round key data comprises initial round key data and first to Nth round key data.

14. The processor of claim 13, wherein, during the initial round, the processor is further configured to perform the XOR operation on the plaintext data and the initial round key data.

15. The processor of claim 14, wherein M is a positive integer greater than or equal to one and smaller than or equal to (N−1), and during an Mth round among the first to Nth rounds, the processor is further configured to:
perform the substitution operation on the first calculation output using the SBOX;
perform the row transformation operation on the second calculation output;
perform the column transformation operation on the third calculation output using the SBOX and the TBOX to obtain the fourth calculation output; and
perform the XOR operation on the fourth calculation output and Mth round key data.

16. The processor of claim 15, wherein, during the Nth round, the processor is further configured to:
perform the substitution operation on the first calculation output using the SBOX,
perform the row transformation operation on the second calculation output, and
generate the ciphertext data by performing the XOR operation on the third calculation output and the Nth round key data.

17. A memory controller comprising:
a processor; and
a buffer memory configured to temporarily store data that is processed by the processor;
wherein the processor is configured to perform an encryption operation to:
perform an XOR operation on first data based on one of a plurality of round key data to obtain a first calculation output;
perform a substitution operation on the first calculation output using a substitution box (SBOX) that is implemented based on a first corrected lookup table converted from a first standard lookup table, to obtain a second calculation output;
perform a row transformation operation on the second calculator output to obtain a third calculation output;
perform a column transformation operation on the third calculation output using the SBOX and a transformation box (TBOX) that is implemented based on second corrected lookup table converted from second standard lookup table, to obtain a fourth calculation output; and
obtain ciphertext data based on the third calculation output and the fourth calculation output.

18. The memory controller of claim 17, wherein the processor is further configured to:
perform a decryption operation on second data that is received from the buffer memory.

19. The memory controller of claim 18, wherein the processor is further configured to perform the encryption operation and the decryption operation that are implemented based on advanced encryption standard (AES) standard.

20. An encryption method performed by at least one processor, the encryption method comprising:
performing an XOR operation on plaintext data based on one of a plurality of round key data to obtain a first calculation output;
performing a substitution operation on the first calculation output using a substitution box (SBOX) that is implemented based on a first corrected lookup table converted from a first standard lookup table, to obtain a second calculation output;
performing a row transformation operation on the second calculation output to obtain a third calculation output;
performing a column transformation operation on the third calculation output using the SBOX and a transformation box (TBOX) that is implemented based on a second corrected lookup table converted from a second standard lookup table, to obtain a fourth calculation output; and
obtaining ciphertext data based on the third calculation output and the fourth calculation output.
